(19) United States
(12) Patent Application Publication
(10) Pub. No.: US 2025/0077780 A1
(43) Pub. Date: Mar. 6, 2025

(54) METHOD AND APPARATUS FOR INVOKING A PLUGIN OF A LARGE LANGUAGE MODEL, DEVICE, AND STORAGE MEDIUM

(71) Applicant: Beijing Baidu Netcom Science Technology Co., Ltd., Beijing (CN)

(72) Inventors: Yongkang Xie, Beijing (CN); Guming Gao, Beijing (CN); Penghao Zhao, Beijing (CN); Xue Xiong, Beijing (CN); Qian Wang, Beijing (CN); Dongze Xu, Beijing (CN); En Shi, Beijing (CN); Yuxuan Li, Beijing (CN); Sheng Zhou, Beijing (CN); Shupeng Li, Beijing (CN); Yao Wang, Beijing (CN); Zhou Xin, Beijing (CN)

(21) Appl. No.: 18/748,642

(22) Filed: Jun. 20, 2024

(30) Foreign Application Priority Data
Aug. 30, 2023 (CN) 202311109373.8

(51) Int. Cl. G06F 40/30; G06F 40/40

(52) U.S. Cl. CPC G06F 40/30; G06F 40/40

(57) ABSTRACT

A method for invoking a plugin of a large language model includes: acquiring natural language content; performing semantic understanding on the natural language content and detecting whether the natural language content hits a plugin to obtain a first plugin pointed to by the plugin hit result; comparing the first plugin with a second plugin corresponding to the current session understanding task to determine a to-be-executed session understanding task and a third plugin corresponding to the to-be-executed session understanding task; acquiring the language understanding content of the to-be-executed session understanding task and sending the language understanding content to the large language model to obtain the input parameter of the third plugin; and calling the third plugin according to the input parameter of the third plugin to obtain the calling result of the to-be-executed session understanding task.

### CROSS-REFERENCE TO RELATED APPLICATION

This application claims the priority to Chinese Patent Application No. CN2023111093738, filed on Aug. 30, 2023, the disclosure of which is incorporated herein by reference in its entirety.

### TECHNICAL FIELD

The present disclosure relates to the field of large models, for example, a method and apparatus for invoking a plugin of a large language model, device, and storage medium.

### BACKGROUND

In recent years, the understanding and generation capabilities of large language models are greatly improved, and the application field of the large language models is also widely expanded.

A large language model (LLM, which is essentially a generative model) refers to a deep learning model trained using large amounts of text data. The large language model may understand the meaning of a language text and generate content that satisfies user intent, for example, executing tasks, performing man-machine dialogue, answering questions, and generating images.

### SUMMARY

The present disclosure provides a method and an apparatus for invoking a plugin of a large language model, device, and medium.

According to an aspect of the present disclosure, a method for invoking a plugin of a large language model is provided and includes the steps described below.

Natural language content is acquired.

Semantic understanding is performed on the natural language content, and whether the natural language content hits a plugin is detected to obtain a first plugin pointed to by the plugin hit result.

The first plugin is compared with a second plugin corresponding to the current session understanding task to determine a to-be-executed session understanding task and a third plugin corresponding to the to-be-executed session understanding task.

The language understanding content of the to-be-executed session understanding task is acquired and sent to a large language model to obtain the input parameter of the third plugin.

The third plugin is called according to the input parameter of the third plugin to obtain the calling result of the to-be-executed session understanding task.

According to an aspect of the present disclosure, an apparatus for invoking a plugin of a large language model is provided. The apparatus includes a natural language content acquisition module, a plugin matching module, a session understanding task determination module, an input parameter detection module, and a plugin calling module.

The natural language content acquisition module is configured to acquire the natural language content.

The plugin matching module is configured to perform semantic understanding on the natural language content and detect whether the natural language content hits the plugin to obtain the first plugin pointed to by the plugin hit result.

The session understanding task determination module is configured to compare the first plugin with the second plugin corresponding to the current session understanding task to determine the to-be-executed session understanding task and the third plugin corresponding to the to-be-executed session understanding task.

The input parameter detection module is configured to acquire the language understanding content of the to-be-executed session understanding task and send the language understanding content to the large language model to obtain the input parameter of the third plugin.

The plugin calling module is configured to call the third plugin according to the input parameter of the third plugin to obtain the calling result of the to-be-executed session understanding task.

According to another aspect of the present disclosure, an electronic device is provided. The electronic device includes the following.

At least one processor is provided.

A memory communicatively connected to the at least one processor is provided.

The memory stores instructions executable by the at least one processor to enable the at least one processor to execute the method according to any embodiment of the present disclosure.

According to another aspect of the present disclosure, a non-transitory computer-readable storage medium is provided. The storage medium stores computer instructions for causing a computer to perform the method according to any embodiment of the present disclosure.

According to another aspect of the present disclosure, a computer program product is provided. The computer program product includes a computer program. When executing the computer program, a processor performs the method according to any embodiment of the present disclosure.

In embodiments of the present disclosure, the execution efficiency of a language understanding task can be improved.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1 is a flowchart of a method for invoking a plugin of a large language model according to an embodiment of the present disclosure.

FIG. 2 is a flowchart of a method for invoking a plugin of a large language model according to another embodiment of the present disclosure.

FIG. 3 is a flowchart of a method for invoking a plugin of a large language model according to another embodiment of the present disclosure.

FIG. 4 is a scene graph of a method for invoking a plugin of a large language model according to an embodiment of the present disclosure.

FIG. 5 is a scene graph of a method for invoking a plugin of a large language model according to an embodiment of the present disclosure.

FIG. 6 is a diagram illustrating the structure of an apparatus for invoking a plugin of a large language model according to an embodiment of the present disclosure.

FIG. 7 is a block diagram of an electronic device implementing a method for invoking a plugin of a large language model according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only.

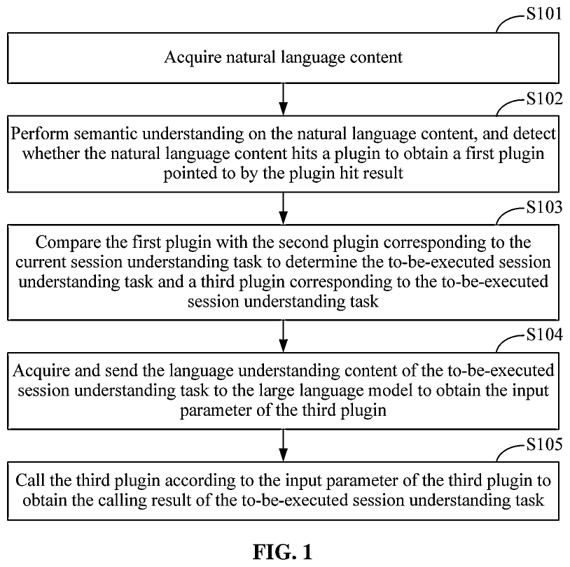

FIG. 1 is a flowchart of a method for invoking a plugin of a large language model according to an embodiment of the present disclosure. This embodiment may be applicable to the case where a plugin is extended for a large language model. The method in this embodiment may be executed by an apparatus for invoking a plugin of a large model. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, or a desktop computer.

An apparatus or a system for executing a method for invoking a plugin of a large language model provided in this embodiment of the present disclosure is located between a large language model and a plugin and is configured to establish a bridge between the plugin and the large language model, so that any plugin can be docked to a large language model of any function. The apparatus or the system for executing a method for invoking a plugin of a large model provided in this embodiment of the present disclosure may interact with the plugin through an application programming interface (API) and interact with the client through the API to acquire the natural language content provided by a user sent by the client.

In S101, natural language content is acquired.

The natural language content may refer to the natural language content input by the user during a human-computer interaction process. The natural language content may be understood as content provided by the user that includes user intent to call the large language model to implement required functions. The user may input data in at least one type of form such as a text, an image, a voice, or a video, and the directly input data is recognized to obtain the natural language content. The client may receive data input by the user and send the data to the electronic device in this embodiment of the present disclosure. The electronic device acquires the natural language content according to the input data.

In S102, semantic understanding is performed on the natural language content, and whether the natural language content hits a plugin is detected to obtain a first plugin pointed to by the plugin hit result.

Semantic understanding is used for recognizing the user intent in the natural language content. The first plugin hit by the natural language content may refer to a plugin that implements the function of the user intent. The number of first plugins may be a non-negative integer. The plugin hit result may refer to a detection result of whether the natural language content hits the plugin and related information of the hit first plugin. The plugin hit result includes a hit result or a miss result. When the plugin hit result is that the natural language content hits the plugin, the hit plugin is determined as the first plugin. If the current session understanding task exists, the plugin corresponding to the current session understanding task is determined as a second plugin. The plugin hit result may also include the first plugin corresponding to the hit result, the number of first plugins, and whether the first plugin is consistent with the second plugin. When the plugin hit result is that the natural language content does not hit the plugin, the first plugin is empty. The plugin hit result may be used for determining which task the to-be-executed session understanding task is, for example, whether the task is the current session understanding task or a new session understanding task. Semantic understanding may be performed on the natural language content to obtain the user intent. The user intent may be matched with the function of each available plugin, and the plugin corresponding to the user intent may be determined as the first plugin. Semantic understanding may be implemented by using a deep learning model, and the user intent may be matched with the plugin by using the deep learning model.

In S103, the first plugin is compared with the second plugin corresponding to the current session understanding task to determine the to-be-executed session understanding task and a third plugin corresponding to the to-be-executed session understanding task.

The session understanding task may refer to a task that provides the natural language content to the large language model, acquires the input parameter of the first plugin hit by the natural language content fed back by the large language model, and calls the first plugin to obtain a calling result and feed back the calling result to the user. The current session understanding task is a session understanding task in the current execution state. The to-be-executed session understanding task may refer to a session understanding task that has the highest current priority and needs to be executed immediately. The to-be-executed session understanding task may be the same as or different from the current session understanding task. The to-be-executed session understanding task is used for calling the first plugin hit by the natural language content. Actually, the natural language content may be the natural language content input by the user during multiple rounds of sessions. For example, during the i-th round of session, the initial session understanding task in the i-th round of session is the current session understanding task, that is, the to-be-executed session understanding task determined in the i-th round of session. The to-be-executed session understanding task is determined based on the natural language content input by the user in the i-th round, that is, the to-be-executed session understanding task determined in the i-th round of session is also used as the initial conversation understanding task in the (i+1)-th round of session. The to-be-executed session understanding task in the i-th round may be the same as or different from the current session understanding task in the i-th round. If the to-be-executed session understanding task in the i-th round is the same as the current session understanding task in the i-th round, the current session understanding task continues to maintain the current execution state. If the to-be-executed session understanding task in the i-th round is different from the current session understanding task in the i-th round, the current session understanding task is replaced by the to-be-executed session understanding task in the i-th round, that is, the to-be-executed session understanding task is set in the current execution state. Actually, the session understanding task is placed in a task stack. When a task is executed, a task on the stack top is executed, that is, the task on the top of the stack is a session understanding task in the current execution state. After the context is stored correspondingly, the current session understanding task is placed on a secondary stack top, and the to-be-executed session understanding task is placed on the stack top, that is, the current execution state of the task is adjusted.

The first plugin is compared with the second plugin corresponding to the current session understanding task to determine whether the session state is interrupted and determine the to-be-executed session understanding task according to whether the session state is interrupted. Specifically, the first plugin is compared with the second plugin to detect whether the intent of the previous session and the intent of the subsequent session are the same, thereby detecting whether the session state is interrupted. For example, the session is interrupted, and a newly selected session understanding task after the interruption is used as the to-be-executed session understanding task, that is, the task of the previous session and the task of the subsequent session change; and the session is held, and the current session understanding task is determined as the to-be-executed session understanding task, that is, the task of the previous session and the task of the subsequent session remain unchanged. The corresponding plugin is determined according to the content of the to-be-executed session understanding task. For example, a newly selected session understanding task after the interruption is used as the to-be-executed session understanding task, and the third plugin is the first plugin. For another example, the current session understanding task is determined as the to-be-executed session understanding task, and the third plugin is the second plugin and the first plugin, or the union set of the first plugin and the second plugin. In addition, other cases are not limited.

In S104, the language understanding content of the to-be-executed session understanding task is acquired and sent to the large language model to obtain the input parameter of the third plugin.

The language understanding content is the input of the large language model. The language understanding content includes the related information of the third plugin corresponding to the session understanding task and the natural language content of the session understanding task and may also include other content, such as a context, which is not limited herein. The related information of the third plugin may be queried, and the related information of the third plugin and the natural language content are combined to obtain the language understanding content.

The parameter value of the input parameter is the input information of the third plugin. The third plugin processes the parameter value of the input parameter to obtain the calling result.

The related information of the third plugin and the natural language content are provided to the large language model. The large language model is responsible for semantic understanding, and necessary information for calling the third plugin is generated. The necessary information may include the input parameter of the third plugin and the parameter value of the input parameter. The related information of the third plugin may include information such as the function and input and output of the third plugin. The language understanding content is sent to the large language model to obtain the input parameter of the third plugin and the parameter value corresponding to the input parameter.

It is to be noted that in this embodiment of the present disclosure, the input parameter of the third plugin may specifically include at least one of the following: the input parameter, the parameter value of the input parameter, or the parameter type of the input parameter.

In S105, the third plugin is called according to the input parameter of the third plugin to obtain the calling result of the to-be-executed session understanding task.

The execution process of a session understanding task is that: For the session understanding task, data that conforms to a plugin call protocol is generated based on the parameter value of the input parameter and is sent to the third plugin to call the third plugin. The third plugin obtains the calling result based on the input parameter and the parameter value and feeds back the calling result. There may be at least one third plugin. The input parameters of third plugins may be detected and called one by one. In this embodiment of the present disclosure, the electronic device receives the calling result fed back by the third plugin. The calling result may be fed back to the client and provided to the user by the client.

For example, the to-be-executed session understanding task is: querying the local weather today. The third plugin is a weather query plugin. The input parameter includes a time parameter and a location parameter. The parameter value of the time parameter is today, and the parameter value of the location parameter is local. The calling result of the third plugin is that the local weather is clear today.

For example, the to-be-executed session understanding task is: reserving a double room at hotel A. The third plugin is a hotel reservation plugin. The input parameter includes a hotel name parameter and an occupant number parameter. The parameter value of the hotel name parameter is A, and the parameter value of the occupant number parameter is 2. The calling result of the third plugin is the information of the reservation for the double room at hotel A.

In this embodiment of the present disclosure, the large language model does not need specific training for different user intent or different application scenarios and only needs to have the ability to understand languages and generate plugin input information to implement the calling function of the plugin of the user intent, thereby increasing the generality of the large language model.

There are some defects in the existing large language model. For example, due to the limitation of the timeliness of the pre-training data set, the large language model often fails to correctly answer an objective fact problem that occurs after the pre-training time. The large language model cannot directly implement the functions that depend on external resources, such as booking tickets and ordering meals. Currently, supervised learning may be performed on the large language model to implement plugin extension of the large language model. The cost of adding plugins through training and optimization for the large language model is high each time. Generally, it is necessary to train the instruction data sets of all plugins, which makes it difficult for the large language model to flexibly and timely expand a plugin. At the same time, due to the optimization of plugin triggering, the large language model is affected. Thus, it is also difficult to customize the scope and triggering of the plugin for different users. In addition, a specific large language model has a corresponding function through training and optimization. Thus, for other large language models, even the same plugin needs to be optimized and trained specifically again. Specific training and optimization cannot be applied to other large language models and are not universal.

In addition, the large language model triggers plugins and implements functional expansion by rewriting the input and adding prompts. However, since the functions and required parameters of the plugin are described simply through prompt templates, the execution effects may vary greatly for large language models having different understanding and generation capabilities, resulting in unstable prediction effects of large language models. This may cause plugins that may be normally triggered and called on some large language models having strong understanding and generation capabilities to fail to be triggered normally on other large language models having weaker understanding and generation capabilities. At the same time, there is often no specific optimization for task planning, including whether the task planning is repeatedly executed and whether the task planning may be combined to avoid unnecessary execution, resulting in low execution efficiency.

According to the technical solution of the present disclosure, semantic understanding is performed on the natural language content. Whether the user intent hits the plugin is detected. The to-be-executed session understanding task is determined according to the plugin hit result. The language understanding content of the session understanding task is acquired and sent to the large language model. The large language model understands the natural language content, and the parameter value of the input parameter required for running the third plugin is extracted, so that the parameter value of the input parameter fed back by the large language model is obtained, and the third plugin is called. The calling result of the session understanding task is obtained. External resources are acquired based on the large language model. The understanding capabilities of the large language model and the external resources may be used to overcome the timeliness defect and resource limitation of the large language model. The application scenarios of language understanding and generation of a large language model system are increased. The prediction accuracy for language understanding generation tasks is improved. Moreover, a variety of plugins may be expanded in real time to increase the diversity and flexibility of extended functions, and the universality of plugins may be increased. At the same time, the large language model does not need to be trained for a scenario to improve the generality of the large language model. At the same time, the plugin pointed to by the plugin hit result is compared with the plugin corresponding to the current session understanding task to determine the to-be-executed session understanding task. Thus, the session understanding task may be planned and determined to avoid unnecessary execution and improve execution efficiency.

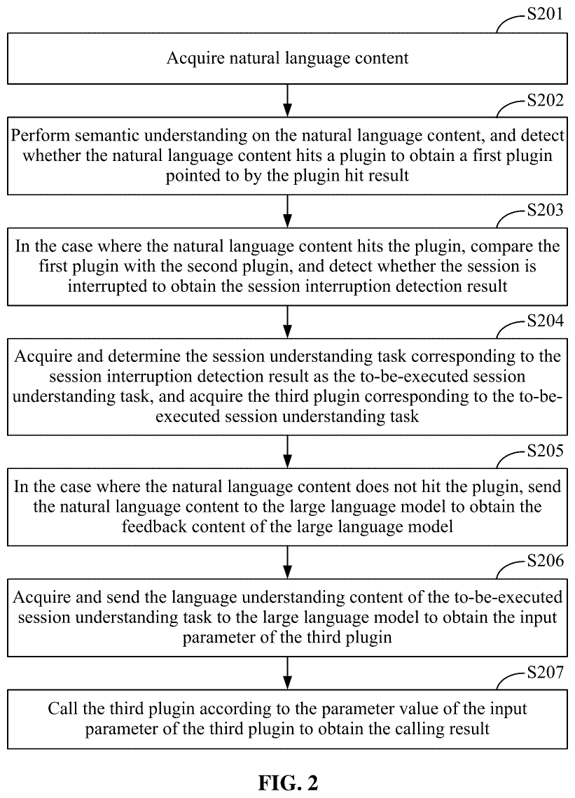

FIG. 2 is a flowchart of a method for invoking a plugin of a large model according to an embodiment of the present disclosure. This embodiment is an optimization and expansion of the preceding technical solutions and can be combined with each preceding optional embodiment. The first plugin is compared with the second plugin corresponding to the current session understanding task to determine the to-be-executed session understanding task. Specifically, in the case where the plugin hit result is that the natural language content hits the plugin, the first plugin pointed to by the plugin hit result is compared with the second plugin to detect whether the session is interrupted to obtain a session interruption detection result. The session understanding task corresponding to the session interruption detection result is acquired and determined as the to-be-executed session understanding task. In the case where the plugin hit result is that the natural language content does not hit the plugin, the natural language content is sent to the large language model to obtain the feedback content of the large language model.

In S201, the natural language content is acquired.

In S202, semantic understanding is performed on the natural language content, and whether the natural language content hits the plugin is detected to obtain the first plugin pointed to by the plugin hit result.

In S203, in the case where the plugin hit result is that the natural language content hits the plugin, the first plugin pointed to by the plugin hit result is compared with the second plugin to detect whether the session is interrupted to obtain the session interruption detection result.

The first plugin pointed to by the plugin hit result is a plugin hit by the natural language content. There may be at least one first plugin. The at least one first plugin may be compared with at least one second plugin corresponding to the current session understanding task, and whether the session is interrupted is determined according to a comparison result showing that the two are the same as or different. The session interruption detection result indicates whether the intent of the session corresponding to the natural language content is the same as the intent of the adjacent previous round of session. If the intent is different, the session is interrupted. If the intent is the same, the session is held. It is to be noted that the session user of the natural language content is the same as the session user of the adjacent previous round of session. If the session users are different, it may be determined that the session is interrupted. If the session users are the same, the first plugin is compared with the second plugin to detect whether the session is interrupted. The session interruption detection result may include session interruption and session holding.

In S204, the session understanding task corresponding to the session interruption detection result is acquired and determined as the to-be-executed session understanding task, and the third plugin corresponding to the to-be-executed session understanding task is acquired.

Different session interruption detection results correspond to different session understanding tasks and correspond to different third plugins. For example, when the to-be-executed session understanding task is a new session understanding task, the first plugin is determined as the third plugin. When the to-be-executed session understanding task is an existing session understanding task, the plugin corresponding to the existing session understanding task may be determined as the third plugin. Alternatively, the union set of the plugin corresponding to the existing session understanding task and the first plugin is determined as the third plugin.

In S205, in the case where the plugin hit result is that the natural language content does not hit the plugin, the natural language content is sent to the large language model to obtain the feedback content of the large language model.

The plugin hit result is that the natural language content does not hit the plugin, which indicates that the intent of the natural language content cannot be implemented through the function provided by a currently registered alternative plugin. The natural language content may be directly sent to the large language model for semantic understanding and receiving the feedback content. For example, the natural language content of the previous round of the user is a weather query, and the natural language content of the current round is writing a paper on the topic of user requirements. The feedback content of the large language model is the paper content required by the user.

At the same time, since the plugin is not hit, a new session understanding task is not generated, which may be understood as session holding. The current session understanding task is determined as the to-be-executed session understanding task, that is, the current session understanding task remains in the current execution state.

In S206, the language understanding content of the to-be-executed session understanding task is acquired and sent to the large language model to obtain the input parameter of the third plugin.

In S207, the third plugin is called according to the parameter value of the input parameter of the third plugin to obtain the calling result.

Optionally, the first plugin is compared with the second plugin corresponding to the current session understanding task to detect whether the session is interrupted to obtain the session interruption detection result in the following manners: In the case where the first plugin is the same as the second plugin, it is determined that the session interruption detection result is that the session is held; and in the case where the first plugin is different from the second plugin, it is determined that the session interruption detection result is that the session is interrupted. The session understanding task corresponding to the session interruption detection result is acquired in the following manners: In the case where the session interruption detection result is that the session is held, the current session understanding task is determined as the session understanding task corresponding to the session interruption detection result: in the case where the session interruption detection result is that the session is interrupted, whether a historical session is recovered is detected to obtain a session recovery detection result; and the session understanding task corresponding to the session recovery detection result is acquired and used as the session understanding task corresponding to the session interruption detection result.

The first plugin is the same as the second plugin, which indicates that the intent of the natural language is the same as the intent of the current session understanding task, that is, the intent of the current round of session is the same as the intent of the previous round of session, that is, the intent of the previous session is the same as the intent of the subsequent session, and it is determined that the session is held. The current session understanding task is determined as the to-be-executed session understanding task, and the second plugin corresponding to the current session understanding task may be determined as the third plugin corresponding to the to-be-executed session understanding task. At this time, the first plugin is the same as the second plugin. The second plugin is determined as the third plugin. Equivalently, the first plugin is determined as the third plugin. Accordingly, the to-be-executed session understanding task is used for calling the first plugin. The first plugin is different from the second plugin, which indicates that the intent of the natural language is different from the intent of the current session understanding task, that is, the intent of the current round of session is different from the intent of the previous round of session, that is, the intent of the previous session is different from the intent of the subsequent session, and it is determined that the session is interrupted. When there are multiple first plugins and multiple second plugins, as long as any first plugin is the same as a second plugin, it is determined that the first plugin is the same as the second plugin.

For example, the second plugin is for reserving a hotel. For example, the natural language content states that I want to book a flight ticket for today. Accordingly, the first plugin is for booking a flight ticket. The first plugin is different from the second plugin, and it is determined that the session is interrupted. For another example, the natural language content states that I want to reserve a room at XX Hotel. Accordingly, the first plugin is for reserving a hotel. The first plugin is the same as the second plugin, and it is determined that the session is held.

It is to be understood that there may be multiple session understanding tasks for the same user, and session understanding tasks for different users may be executed in parallel. Generally, the number of session understanding tasks executed at the same time by the same user is one. That is, for the same user, the current session understanding task is the session understanding task in the current execution state, and other session understanding tasks are in a to-be-executed state and are executed after the current session understanding task is executed.

The session interruption may be to generate a new session or recover to the previous session. The session recovery detection result may include session recovery or session non-recovery. Different session recovery detection results correspond to different session understanding tasks. When it is determined that the session is interrupted, it may be detected whether the first plugin is the same as a fourth plugin corresponding to a historical session understanding task to determine whether the session is recovered.

When the session is interrupted, whether the session is recovered is further detected. The session understanding task corresponding to the session recovery detection result is determined as the to-be-executed session understanding task. In this manner, the session understanding task may be repeatedly detected to reduce redundant tasks. At the same time, there are corresponding processing methods for recovery and non-recovery to improve the stability of a plugin calling system.

Optionally, whether the historical session is recovered is detected to obtain the session recovery detection result in the following manners: In the case where the first plugin is the same as the fourth plugin corresponding to the historical session understanding task, it is determined that the session recovery detection result is that the session is recovered; and in the case where the first plugin is different from the fourth plugin, it is determined that the session recovery detection result is that the session is not recovered. The session understanding task corresponding to the session recovery detection result is acquired in the following manners: In the case where the session recovery detection result is that the session is recovered, the historical session understanding task is acquired and determined as the session understanding task corresponding to the session recovery detection result; and in the case where the session recovery detection result is that the session is not recovered, a new session understanding task is established and determined as the session understanding task corresponding to the session recovery detection result.

The historical session understanding task may be a session understanding task generated through a historical session that hits the fourth plugin but is not in the current execution state. Generally, the intent of the historical session is different from the intent of the current session, and the corresponding plugins are different. The historical session understanding task is usually placed at a position other than the top of a task stack. The first plugin is the same as the fourth plugin corresponding to the historical session understanding task, which indicates that the intent of the natural language is the same as the intent of the historical session understanding task, that is, the intent of the current round of session is the same as the intent of a historical round of session, and it is determined that the session is recovered to the historical session for continuous interaction. Recovering to the previous session indicates that the immediately executed session understanding task may be other session understanding tasks except the current session understanding task. The session understanding task in a to-be-executed state may be changed to be in an executing state. Specifically, a historical session understanding task that has the same fourth plugin as any first plugin is used as the to-be-executed session understanding task. If there are multiple historical session understanding tasks that have the same plugin, a historical session understanding task may be randomly selected, or a historical session understanding task having the largest number of the same first plugins may be selected. The historical session understanding task is determined as the to-be-executed session understanding task, and the second plugin corresponding to the historical session understanding task is determined as the third plugin corresponding to the to-be-executed session understanding task. At this time, the first plugin is the same as the fourth plugin. The fourth plugin is determined as the third plugin. Equivalently, the first plugin is determined as the third plugin. Accordingly, the to-be-executed session understanding task is used for calling the first plugin.

The first plugin is different from the fourth plugin, which indicates that the intent of the natural language is different from the intent of the historical session understanding task, that is, the intent of the current round of session is different from the intent of any historical round of session, that is, there is no duplicate session, and it is determined that the session is not recovered. At this time, a new session understanding task is directly created and used as the to-be-executed session understanding task. The historical session understanding task may be empty. At this time, a new session understanding task is directly created and used as the to-be-executed session understanding task. The new session understanding task is determined as the to-be-executed session understanding task, and the first plugin hit by the natural language is determined as the third plugin corresponding to the to-be-executed session understanding task. At this time, the first plugin is different from the second plugin, and the first plugin is different from the fourth plugin.

As in the previous example, the second plugin is for reserving a hotel. For example, the natural language content states that I want to book a flight ticket for today. Accordingly, the first plugin is for booking a flight ticket. The first plugin is different from the second plugin, and it is determined that the session is interrupted. For example, the fourth plugin is for booking a flight ticket. The first plugin is the same as the fourth plugin, and it is determined that the session is recovered. The historical session understanding task corresponding to flight ticket booking is determined as the to-be-executed session understanding task, and the corresponding third plugin is the fourth plugin, that is, booking a flight ticket. For another example, the fourth plugin is for ordering takeout. The first plugin is different from the fourth plugin, and it is determined that the session is not recovered. The new session understanding task is generated and determined as the to-be-executed session understanding task, and the corresponding third plugin is for booking a flight ticket.

If a fourth plugin is the same as the first plugin, it is determined that the session is recovered. The historical session understanding task is selected and determined as the to-be-executed session understanding task. If any fourth plugin is different from the first plugin, it is determined that the session is not recovered. The new session understanding task is created so that the session understanding task corresponding to the historical session may be recovered and executed, or the new session understanding task is created. At the same time, there are corresponding processing methods for recovery and non-recovery to improve the stability of the plugin calling system. Moreover, repeated tasks are merged, task redundancy is reduced, and execution efficiency is improved.

Optionally, the new session understanding task is established in the following manners: At least one first plugin pointed to by the plugin hit result is acquired: at least one plugin task corresponding to the at least one first plugin is generated; and the at least one plugin task is determined as the new session understanding task.

There may be at least one first plugin, and a corresponding plugin task may be generated according to each first plugin. At least one plugin task is in one-to-one correspondence with the at least one first plugin. Actually, the user intent corresponding to the natural language content may relate to implementation of multiple functions. For example, the natural language content states that I want to travel. This intent may involve weather queries, flight ticket booking, attraction ticket booking, and hotel reservation. Each specific function needs to be implemented by a plugin. Plugins may be executed independently or dependently on each other. A corresponding plugin task is generated for each plugin. At the same time, the relationship and execution order between the plugin tasks may also be determined according to the dependency relationship and priority of the plugins during execution.

The intent involved in the natural language content is determined as a session understanding task, and a corresponding plugin task is generated according to the function of the first plugin and is used as the plugin task corresponding to the session understanding task. Actually, the same session understanding task is created based on the same intent. Corresponding plugin tasks are established separately based on multiple different first plugin tasks hit by the same intent, and the corresponding relationship between the session understanding task and the multiple plugin tasks is established.

The session understanding task is analyzed, disassembled, and planned according to the first plugin to improve the flexibility and efficiency of plugin execution. Thus, the plugin task may be managed to facilitate tracking the execution of the plugin task, timely locate an abnormality, and perform system intervention on a specific task, thereby improving the running stability of the plugin calling system.

In addition, when the to-be-executed session understanding task is the current session understanding task, and the third plugin is the second plugin, the first plugin is the same as the second plugin, and equivalently, the third plugin includes the first plugin. When the to-be-executed session understanding task is the historical session understanding task, and the third plugin is the fourth plugin, the first plugin is the same as the fourth plugin, and equivalently, the third plugin includes the first plugin. When the to-be-executed session understanding task is the new session understanding task, and the third plugin is the first plugin, so that no matter which hit situation, the to-be-executed session understanding task is essentially used for calling the first plugin hit by the natural language content.

Optionally, the method also includes sorting each plugin task. Each plugin task in the new session understanding task is executed according to the sorting result. The language understanding content of the to-be-executed session understanding task is acquired and sent to the large language model to obtain the input parameter of the third plugin in the following manners: The language understanding content of the currently executed plugin task in the to-be-executed session understanding task is acquired; and the language understanding content of the currently executed plugin task is sent to the large language model to obtain the input parameter of the third plugin corresponding to the currently executed plugin task. The third plugin is called according to the input parameter of the third plugin to obtain the calling result of the to-be-executed session understanding task in the following manner: The third plugin is called according to the input parameter of the third plugin corresponding to the currently executed plugin task to obtain the calling result of the currently executed plugin task.

The plugin tasks in the same session understanding task of the same user are usually executed one by one. The sorting result of each plugin task may be determined according to the dependency relationship of the first plugin during calling, the priority of the first plugin, and the importance of the specific intent corresponding to the first plugin. The new session understanding task is determined as the to-be-executed session understanding task. The plugin task included in the new session understanding task is determined as the plugin task included in the to-be-executed session understanding task. The first plugin corresponding to the new session understanding task is determined as the third plugin corresponding to the to-be-executed session understanding task. When the to-be-executed session understanding task is executed, the plugin tasks corresponding to the to-be-executed session understanding task are executed in sequence or in parallel according to the sorting result. The plugin tasks executed in parallel are independent of each other.

The language understanding content of the plugin task may be obtained by combining the description information of the input parameter of the third plugin corresponding to the plugin task and the natural language content. In addition, the description information of the input parameter and the natural language content may be combined with the context of the session understanding task or the context of the plugin task to obtain the language understanding content of the plugin task.

The input parameter of the third plugin corresponding to the currently executed plugin task fed back by the large language model specifically includes the identifier, parameter value, and parameter type of the input parameter. The input parameter corresponding to the currently executed plugin task is acquired, and the third plugin corresponding to the currently executed plugin task is called to obtain the calling result. After the calling result is fed back, the next plugin task is selected and used as the currently executed plugin task. The preceding steps are repeated until all the plugin tasks in the same session understanding task are executed to obtain the calling result of the session understanding task. At this time, the next session understanding task is selected to be executed. When the plugin task is completed, the calling result of the plugin task may be fed back, or the calling result of the plugin task may not be fed back. After all the plugin tasks included in the session understanding task are executed, the calling results of all the plugin tasks are fed back.

In addition, if it is determined that the session is interrupted in the execution process of the plugin task in the same session understanding task, the plugin task is switched to another session understanding task for execution. After another session understanding task is executed, the plugin task in the same session understanding task is returned to be executed. If during the execution of the plugin task, the current session understanding task corresponds to the second plugin, and accordingly, each plugin task included in the current session understanding task corresponds to the second plugin, the third plugin hit by the natural language content is different from the second plugin corresponding to the currently executed plugin task, and the third plugin hit by the natural language content is the same as the second plugin corresponding to other plugin tasks of the same session understanding task. The plugin task is still executed without switching to another plugin task of the same session understanding task for execution. Alternatively, the intervention may be performed through an intervention command, or when the number of switching times is greater than or equal to the threshold of a preset number of times, it is determined that the plugin task is switched to another plugin task of the same session understanding task for execution. In addition, there are other processing methods, which is not limited herein.

Multiple plugin tasks in the same session understanding task are executed in sequence. For the currently executed plugin task, the input parameter is detected, and a corresponding plugin is called to obtain the calling result. An execution plan may be performed on the plugin tasks obtained by splitting plugin calling tasks to improve the plugin calling accuracy and the plugin calling efficiency.

Optionally, the method also includes in the case where the session interruption detection result is that the session is interrupted, adding the natural language content of the current session understanding task to the context of the current session understanding task; and storing the second plugin corresponding to the current session understanding task, the context corresponding to the current session understanding task, and the current session understanding task.

The session understanding task is the first level. The plugin task is the second level. The identifier of the second plugin is the third level. The plugin task corresponds to the second plugin. The context is the fourth level and corresponds to the session understanding task. The session understanding task, the plugin task, the second plugin, and the context may be stored correspondingly to implement the storage data of a multi-layer memory structure.

Multiple layers of memory structures are integrated for multiple rounds of sessions of the plugin, so that sufficient context may be input into the large language model, thereby greatly improving the model understanding accuracy.

According to the technical solution of the present disclosure, whether the session is interrupted is detected. The session understanding task corresponding to the session interruption detection result is determined as the to-be-executed session understanding task. When any pre-registered alternative plugin is not hit, the large language model is directly called to process the natural language content that does not hit the plugin to obtain the feedback content. For different plugin hit scenarios, different processing manners are adaptively used to flexibly respond to different plugin hit scenarios. At the same time, there are corresponding processing methods for hit and miss to improve the stability of the plugin calling system.

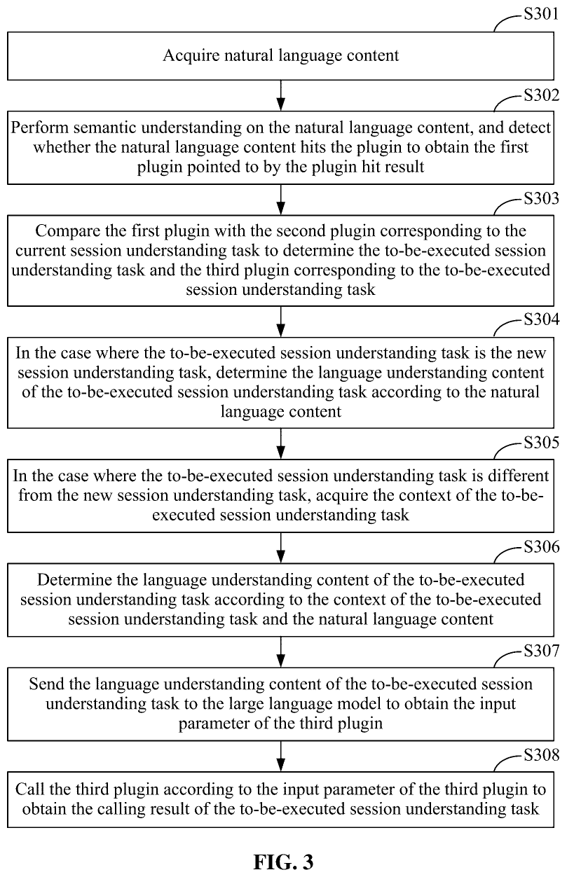

FIG. 3 is a flowchart of a method for invoking a plugin of a large language model according to another embodiment of the present disclosure. This embodiment is an optimization and expansion of the preceding technical solutions and can be combined with each preceding optional embodiment. The language understanding content of the to-be-executed session understanding task is acquired. Specifically, in the case where the to-be-executed session understanding task is a new session understanding task, the language understanding content of the to-be-executed session understanding task is determined according to the natural language content; in the case where the to-be-executed session understanding task is different from the new session understanding task, the context of the to-be-executed session understanding task is acquired; and the language understanding content of the to-be-executed session understanding task is determined according to the context of the to-be-executed session understanding task and the natural language content.

In S301, the natural language content is acquired.

In S302, semantic understanding is performed on the natural language content, and whether the natural language content hits the plugin is detected to obtain the first plugin pointed to by the plugin hit result.

In S303, the first plugin is compared with the second plugin corresponding to the current session understanding task to determine the to-be-executed session understanding task and the third plugin corresponding to the to-be-executed session understanding task.

In S304, in the case where the to-be-executed session understanding task is the new session understanding task, the language understanding content of the to-be-executed session understanding task is determined according to the natural language content.

The new session understanding task indicates that the corresponding natural language content does not include historical session content, that is, there is no context. The natural language content is combined with the information of the plugin corresponding to the new session understanding task to generate the language understanding content of the to-be-executed session understanding task.

All pre-recorded context and the natural language content are provided to the large language model. The large language model may understand the user intent more accurately and generate the content that satisfies user requirements. For example, after the user successfully books a flight ticket, the user enters the ticket booking request again, and the large language model may reply: Do you want to re-book or modify the history booking? Thus, whether the user calls the third plugin to modify the order or generate a new order is clarified to provide more accurate input parameters.

In S305, in the case where the to-be-executed session understanding task is different from the new session understanding task, the context of the to-be-executed session understanding task is acquired.

When the to-be-executed session understanding task is different from the new session understanding task, which indicates that the to-be-executed session understanding task is the current session understanding task or the historical session understanding task. Generally, the natural language content corresponding to the to-be-executed session understanding task has historical session content, that is, there is context.

In S306, the language understanding content of the to-be-executed session understanding task is determined according to the context of the to-be-executed session understanding task and the natural language content.

The context is acquired. The natural language content, the context, and the information of the hit third plugin are combined to generate the language understanding content of the to-be-executed session understanding task.

In S307, the language understanding content of the to-be-executed session understanding task is sent to the large language model to obtain the input parameter of the third plugin.

In S308, the third plugin is called according to the input parameter of the third plugin to obtain the calling result of the to-be-executed session understanding task.

Optionally, the method also includes adjusting the current session understanding task according to the intervention command when the natural language content is an intervention command.

The intervention command is a special command. In this embodiment of the present disclosure, the apparatus may not perform semantic understanding and plugin hit detection on the intervention command, may not generate a corresponding session understanding task, and may not input the intervention command to the large language model for semantic understanding and generation. The intervention command is used for directly executing and adjusting the session understanding task. The intervention command is used for adjusting the current session understanding task in the current execution state. The intervention command may reset or delete memories and states (such as the execution state) when the system fails, so that the object of deleting and adjusting the session understanding task is implemented. The intervention command may be preset, and whether the received natural language content is the same as the intervention command is detected. If the received natural language content is the same as the intervention command, it is determined that the natural language content is the intervention command. Otherwise, it is determined that the natural language content is not the intervention command, and whether the natural language content hits the plugin is detected.

Actually, there may be errors in the semantic understanding of the natural language content. For example, there is an error in the hit first plugin, and there is an error in the generated session understanding task. As a result, the large language task extracts incorrect input parameters. Then, the third plugin is called, and an incorrect calling result is obtained. At this time, the user may choose to restart the session, but may also adjust the current session understanding task through the intervention command. For example, the plugin task in the session understanding task is modified or deleted. When all plugin tasks are deleted, the current session understanding task is deleted. Specifically, the hit second plugin may be modified to correspondingly modify a corresponding plugin task, thereby modifying the current session understanding task. Thus, task splitting and plan intervention are performed on semantic understanding, so that timely intervention is performed on incorrectly predicted task execution paths and output, and resource consumption is reduced.

In addition, the intervention command may also interrupt the execution of the current session understanding task or directly delete the execution of the current session understanding task to respond to the abnormality and collapse of a system caused by the current session understanding task.

In the related art, since the large language model is relied upon as a whole to understand user input and perform task splitting to form task plans, there is a lack of event triggering or human intervention mechanisms. For many scenarios that require deterministic triggering plugins, it is often impossible to accurately predict the actual execution path and final output.

The plugin calling process may be intervened through the intervention command to improve the controllability of the plugin calling process.

According to the technical solution of the present disclosure, when the to-be-executed session understanding task is not the new session understanding task, the language understanding content is generated according to the context, and the sufficient context may be input into the large language model, thereby greatly improving the model understanding accuracy.

In a specific scenario, for each plugin task in the to-be-executed session understanding task, the language understanding content is acquired and sent to the large language model to obtain the parameter value, and the third plugin is called based on the obtained parameter value to obtain and feed back the calling result. The process may include the manners below.

When the to-be-executed session understanding task is executed, for the currently executed plugin task in the to-be-executed session understanding task, the language understanding content is determined according to the third plugin and the natural language content in the following manners: The prompt template corresponding to the third plugin is acquired: the prompt template corresponding to the third plugin includes the input parameter corresponding to the third plugin; and the natural language content is combined with the prompt template corresponding to the third plugin to obtain the language understanding content.

The third plugin may refer to a plugin that implements the function of the user intent. The user intent is obtained through the recognition of the natural language content. A prompt template is a text prompt input to a model. The prompt template includes keywords and context of the information or question to be queried by the user, so that the model better understands the user intent and gives a more accurate response. The prompt template corresponding to the third plugin may refer to a text that prompts the content and type of the input parameter of the third plugin in the natural language content. The prompt template corresponding to the third plugin is configured to recognize the input parameter of the third plugin by the large language model in combination with the natural language content. The prompt template corresponding to the third plugin includes the input parameter of the third plugin and specifically may include the description information of the input parameter. For example, the description information of the input parameter may include at least one of the following: the name of the input parameter, the functional description information of the input parameter, or the type of the input parameter.

The plugin may be registered. When the plugin is registered, the relevant information about the plugin in the registration request is acquired. The prompt template corresponding to the plugin is generated according to the relevant information of the plugin. The prompt template corresponding to the third plugin is searched in the prompt template corresponding to the stored plugin.

The method also includes acquiring the description information of the alternative plugin: extracting the input parameter of the alternative plugin from the description information of the alternative plugin; and combining the input parameter of the alternative plugin with the plugin general-purpose template to obtain the prompt template corresponding to the alternative plugin.

The description information of the alternative plugin may include at least one of the following: the identification (ID), type, function, or input parameter information of the candidate plugin. The information of the input parameter may include at least one of the following: a parameter name, parameter description, or a parameter type.

The plugin general-purpose template is configured to combine the input parameter to form the prompt template that prompts the generation of the input parameter. The plugin general-purpose template may be a template that includes a preset slot, and different input parameters are placed in different slots. Different alternative plugins may be combined with the plugin general-purpose template to generate the prompt templates corresponding to the different alternative plugins. An alternative plugin may be configured with at least one input parameter. All the configured input parameters are combined with the plugin general-purpose template to generate the prompt template corresponding to the alternative plugin. Specifically, the information of the input parameter of the alternative plugin is extracted from the description information of the alternative plugin, for example, the parameter name, parameter description, and parameter type of the input parameter. The information of the input parameter is added to a corresponding position in the plugin general-purpose template. For example, the parameter name is placed after the parameter name field in the plugin general-purpose template and used as the parameter value of the parameter name field. The parameter name, parameter description, and parameter type of the input parameter are placed in the corresponding positions in the plugin general template respectively to obtain the prompt template corresponding to the alternative plugin. The prompt template corresponding to the alternative plugin and the identification, type, and function of the alternative plugin are mapped and stored.

The parameter value of the input parameter of the third plugin is obtained in the following manners: In the case where it is determined that the acquisition of the current input parameter of the third plugin is missed, the session content fed back by the large language model is acquired and fed back to the user to prompt the user to provide the parameter value of the input parameter of the third plugin: new natural language content provided by the user is acquired: new language understanding content is determined based on the new natural language content and sent to the large language model; and in the case where it is determined that the acquisition of the current input parameter of the third plugin is completed, the parameter value of the input parameter of the third plugin fed back by the large language model is acquired.

The acquisition of the input parameter is missed, which may mean that the parameter value of at least one input parameter in the input parameter required by the same third plugin to execute a task is empty. The session content is the request content of a missing input parameter, which is provided to the user to prompt the user to provide the parameter value of the missing input parameter. The large language model is configured to detect whether the acquisition of the current input parameter of the third plugin is missed. When it is determined that the acquisition of the current input parameter of the third plugin is missed, the session content corresponding to the input parameter whose parameter value is empty is generated to prompt the user to feed back the parameter value of the input parameter. The session content is provided to the user. The user replies to the session content, thereby forming multiple rounds of sessions. For example, the third plugin is a weather query plugin, the input parameter of time is missed, and the session content that may be generated is: Which day's weather do you want to query?

The large language model processes new language understanding content and detects whether the acquisition of the input parameter of the same third plugin is missed. At this time, the new natural language content is updated to the current natural language content, and the new language understanding content is updated to the current language understanding content. The large language model detects whether the acquisition of the current input parameter is missed based on the current language understanding content. If it is determined that the acquisition of the current input parameter of the third plugin is missed, the large language model generates the reply content corresponding to the missing input parameter to prompt the user to continue to provide the parameter value of the missing input parameter. Thus, the new natural language content provided by the user for the new reply content is acquired, and multiple rounds of sessions are continued until the current input parameter of the third plugin is acquired.

The description information of the input parameter in the description information of the third plugin is combined with the new natural language content to generate the new language understanding content. Alternatively, the new natural language content is added on the basis of the current language understanding content to obtain the new language understanding content.

The acquisition of the input parameter is completed, which may mean that the parameter values of all input parameters required by the same third plugin to execute a task are assigned non-empty values, and the data type is correct. At this time, the large language model feeds back the parameter data of the third plugin. The parameter data includes the parameter values of all input parameters required by the third plugin to execute a task.

The parameter value of the input parameter of the third plugin fed back by the large language model is acquired in the following manners: The input parameter and the parameter value fed back by the large language model are verified according to the description information of the third plugin: in response to a verification failure event, the language understanding content is sent to the large language model to obtain a new input parameter and a new parameter value, and the input parameter and the parameter value fed back by the large language model are verified; and in response to a verification success event, the parameter value of the input parameter of the third plugin is obtained.

In the description information of a pre-registered alternative plugin, the description information of the third plugin is queried. The input parameter and the parameter value are verified to verify whether the input parameter of the third plugin is acquired completely and whether the data type of the parameter value is correct. The description information of the alternative plugin includes an input parameter and a parameter type. The input parameter included in the description information is compared with the input parameter fed back by the large language model. The parameter type of the input parameter included in the description information is compared with the data type of the same input parameter fed back by the large language model. When the input parameter included in the description information is consistent with the input parameter fed back by the large language model, and the parameter type of the input parameter included in the description information is consistent with the data type of the same input parameter fed back by the large language model, it is determined that the verification is successful. When there is any missing input parameter, or any data type is inconsistent, it is determined that the verification is failed.

In response to the verification failure event, the language content may be repeatedly sent to the large language model, so that the large language model regenerates a parameter value, obtains a new input parameter or a new parameter value fed back by the large language model, and repeatedly verifies the input parameter and the parameter value fed back by the large language model until the verification is successful.

In response to the verification success event, the parameter value and the input parameter fed back by the large language model are determined as the parameter value of the input parameter of the third plugin and sent to the third plugin, and the third plugin is called to obtain the calling result.

It is to be noted that the number of verification failures of the same third plugin is greater than a preset number threshold, an operation and maintenance user may be alerted, and the abnormality is prompted. Alternatively, an abnormally processed preset plugin is called to generate abnormal reply content and feed back the content to the user.

The new language understanding content is determined in the following manner based on the new natural language content: The new natural language content is added to the language understanding content to obtain the new language understanding content.

The language understanding content includes the current natural language content and the description information of the input parameter of the third plugin. The new natural language content is added to the language understanding content to obtain the new language understanding content. Accordingly, the new language understanding content includes the current natural language content, the new natural language content, and the description information of the input parameter of the third plugin.

Semantic understanding is performed on the natural language content to determine the third plugin hit by the natural language content in the following manners: The description information of the pre-registered alternative plugin is acquired; and the third plugin hit by the natural language content is determined according to the description information of each alternative plugin and the natural language content.

The third plugin hit by the natural language content is determined according to the description information of each alternative plugin and the natural language content in the following manner: The natural language content is input into a pre-trained intent recognition model to obtain the identification information of the third plugin output by the intent recognition model. The intent recognition model is configured to determine the identification information corresponding to the natural language content through the natural language content, the description information of each pre-registered alternative plugin, and the registered identification information of each alternative plugin.

The method also includes sending the calling result to the large language model to obtain the calling reply content; and feeding back the calling result and the calling reply content.

The calling reply content may be content for the language description of the calling result. The calling result of the user is fed back in the form of session. For example, the calling result is that calling is successful. The calling reply content is that you have successfully executed the XX operation. The calling reply content and the calling result are fed back together as the feedback content, so that the richness of the reply content may be increased, and the user may also be prompted whether the calling result is the intended function. In this manner, the user can make corrections in time. The large language model may understand the semantics of the calling result and generate the language description content corresponding to the calling result and use the language description content as the calling reply content.

The calling result is sent to the large language model to obtain the calling reply content in the following manners: The reply template corresponding to the third plugin is acquired: the natural language content is combined with the reply template corresponding to the third plugin to obtain the reply understanding content; and the reply understanding content is sent to the large language model to obtain the calling reply content. The calling reply content may be fed back to the user. The plugin task is executed, and the next plugin task is executed.

The reply template may refer to a prompt template and is configured to generate the calling reply content in combination with the calling result. The calling result is combined with the reply template. The calling result may be placed at the end of the reply template for splicing to obtain the reply understanding content. The reply understanding content is the input of the large language model. In addition, the reply template may also be spliced with the context. For example, the context at this time may include the parameter value of the input parameter of a hit parameter, the natural language content, and the content of historical multiple rounds of sessions. Reply templates of different third plugins may be the same or different.

Alternatively, an alternative plugin used for replying may be registered. The reply template may be understood as the prompt template corresponding to the alternative plugin. The reply template, the calling result, and the context are spliced to obtain the reply understanding content. The reply understanding content is sent to the large language model, and the large language model feeds back the parameter value of the input parameter of the alternative plugin. The alternative plugin is called based on the parameter value to obtain the calling reply content.

It is to be noted that if it is determined that the session is interrupted when the input parameter corresponding to the plugin task is acquired, the unexecuted plugin task in the to-be-executed session understanding task is started to be detected and continued to be executed until the to-be-executed session understanding task is executed. If session interruption is triggered, the to-be-executed session understanding task is re-determined, and so on, until all the session understanding tasks are executed.

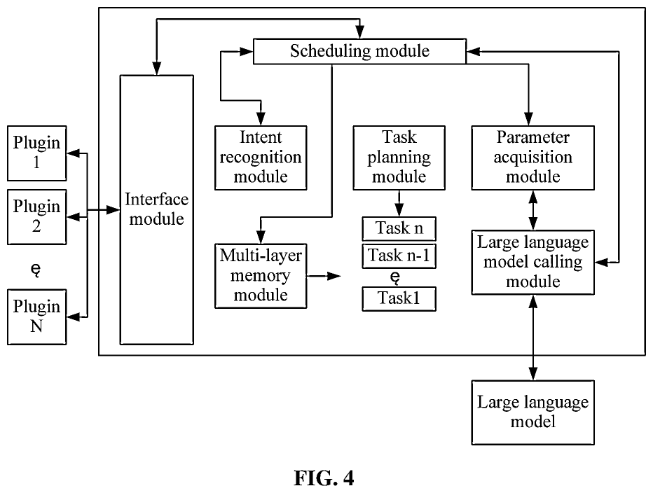

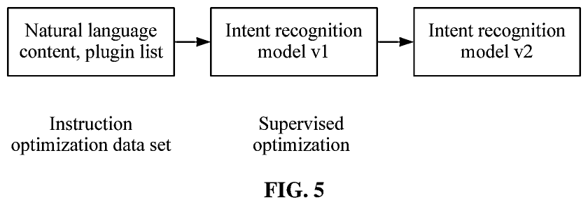

FIG. 4 is a scene graph of a method for invoking a plugin of a large language model according to an embodiment of the present disclosure. FIG. 5 is a scene graph of the training of an intent recognition model. This embodiment of the present disclosure proposes the structure of a large language model general-purpose plugin system for implementing the method as shown in FIG. 4, and the training and optimization process of the intent recognition model is shown in FIG. 5.

As shown in FIG. 4, the plugin system includes an API module, a scheduling module, an intent recognition module, a task planning module, a multi-layer memory module, a parameter acquisition module, and a large language model calling module. The functions and implementation of these seven modules are described below.

The user calls the plugin system by using the API module and inputs a natural language message, a plugin definition message, a plugin execution result parameter structure message, or a system command message. The API module outputs a generation result corresponding to the input message or the callback event of a specific plugin and the input parameter structure required by the plugin. The following json may be used for specific example description:

The example of a plugin system API calling request json
{Message: [{Function: user ID, natural language content: I want to book a flight ticket}],
Plugin: [
{plugin identifier: p_001,
plugin description: flight ticket booking plugin,
Parameter: [
{Input parameter name: XX, parameter description: departure location, parameter type: character type},
{Input parameter name: XX, parameter description: destination location, parameter type: character type},
{Input parameter name: XX, parameter description: departure time, parameter type: time type},
{Input parameter name: XX, parameter description: number of flight tickets, parameter type: integer},
{Input parameter name: XX, parameter description: price requirement, parameter type: character type},
{Input parameter name: XX, parameter description: seat requirement, parameter type: character type},
{Input parameter name: XX, parameter description: identity information, parameter type: character type},},
{plugin identifier: p_002,
plugin description: takeout ordering plugin,
Parameter: [
{Input parameter name: XX, parameter description: takeout delivery location, parameter type: character type},
{Input parameter name: XX, parameter description: takeout store address, parameter type: character type},
{Input parameter name: XX, parameter description: order time, parameter type: time type},
{Input parameter name: XX, parameter description: ordering content, parameter type: character type},
{Input parameter name: XX, parameter description: price requirement, parameter type: character type},
{Input parameter name: XX, parameter description: note requirement, parameter type: character type},}]}

In the preceding examples, a message may include the natural language content sent by the user and the registration information of the flight ticket booking plugin and the registration information of the takeout ordering plugin, and the registration information is the description information of an alternative plugin.

### Example 1 of the Session Content Json Returned by the Large Language Model

Message: [{Function: multiple rounds of sessions, natural language content: When do you plan to leave?}]

The message in the preceding example is the session content fed back by the large language model that needs to be provided to the user, so that the user provides the parameter value of a missing input parameter.

The example of the parameter json returned by the large language model
{Message: [{Function: plugin, message: callback}],

Callback information:
{plugin identifier: p_001,
Parameter: [
{Input parameter name: XX, parameter value: A, parameter type: character type},
{Input parameter name: XX, parameter value: B, parameter type: character type},
{Input parameter name: XX, parameter value: 3 o'clock, parameter type: time type},
{Input parameter name: XX, parameter value: 1, parameter type: integer},
{Input parameter name: XX, parameter value: <1000, parameter type: character type},
{Input parameter name: XX, parameter description: economy class, near the aisle, parameter type: character type},
{Input parameter name: XX, parameter value: 100000000, parameter type: character type}.

The preceding example shows the parameter value of the input parameter of the flight ticket booking plugin fed back by the large language model. Callback is used for calling hit plugin p_001 based on the parameter value, that is, the flight ticket booking plugin.

The example of the calling reply content json returned by the large language model
{Message: [{Function: plugin, message: return}],

Return information:
{plugin identifier: p_001,
Parameter: [
{Input parameter name: XX, parameter description: return code, parameter value: success, parameter type: character type},
{Input parameter name: XX, parameter description: return message, parameter value: You have successfully booked a fight ticket from A to B, departure time 3:00, flight number XX, seat number XX, please board from gate XX, parameter type: character type},]}

The preceding example shows the calling result and calling reply content that booking is succeed of the flight ticket booking plugin fed back by the large language model.

### Example 3 of the Plugin System API Calling Request Json

Message: [{Function: plugin, message: system intervention}],
Intervention command information:
{Parameter: [
Command name: calling plugin
{Input parameter name: XX, parameter value: plugin id, parameter type: character type}]}

The scheduling module is docked to other modules in the plugin system and plays the role of overall control.

The intent recognition model is a small language model having 100 million parameters and is configured to determine whether an input message includes the call intent to one or several plugins. As shown in FIG. 5, the SFT optimization data format is as follows: The intent recognition model v1 is trained by using the {instruction, plugin_list} data set to obtain the intent recognition model v2. Instruction denotes an input message. plugin_list denotes a plugin list related to the message, and the list may be empty. V1 and v2 refer to the version number of the intent recognition model.

For the intent that requires multiple plugins to satisfy by orchestration, the task planning module may generate an ordered plugin execution plan according to the input message and the related plugin list.

The multi-layer memory module is configured to save a global session memory, the session memory of each plugin, and a plugin execution result memory. The global session memory is saved for up to one week. The plugin session memory is saved for up to 72 hours. The plugin execution result memory is saved for up to one week. The memory module can significantly improve the saving of a session and a calling state and the generation effect of the large language model.

The parameter acquisition module accesses a task stack, obtains a plugin task, and acquires various parameters required for plugin task callback by calling the large language model module.

The large language model calling module is responsible for requesting an external large language model and receiving and parsing the generation result of the large language model.

In this embodiment of the present disclosure, the plugin system may be widely applied to personal and enterprise application scenarios in which the capability of a large language model needs to be expanded through a plugin. For example, the plugin system is combined with the large language model, so that a personal user may use a natural language to implement various requirements such as meal ordering, ticket booking, scheduling, document question answering, and factual searching, which is similar to a smart assistant experience. In an enterprise application scenario, the question and answer of an enterprise knowledge base, the summary of meeting minutes, the expansion of mathematical problems, drawing, code generation and execution, graph generation through a natural language, video editing through a natural language, and the copywriting and problem analysis in combination with a knowledge base are included.

In a typical flight ticket booking scenario, the plugin system application solution may include the following steps: First, the user enters the message “booking several flight tickets for me” through an API module, and two plugins, ticket booking and meal ordering, are provided through the plugin parameter of the API module. After the scheduling module receives the message, the intent recognition module is configured to determine that the ticket booking plugin should be used to satisfy the intent of the message. Thus, a task whose plugin identifier is the booking plugin id is added to the task stack, the global session and two levels of memories corresponding to the plugin are updated, and the message “booking several flight tickets for me” is added. Then, the scheduling module calls the parameter acquisition module to execute the first task in the task stack. The parameter acquisition module calls the large language model module for multiple times according to the input parameter requirement of the first task in the stack to obtain the specific parameter value of the required input parameter. During this period, the large language model and the user perform multiple rounds of sessions by using the API module, update the memory module at the corresponding level until all input parameters required by the plugin are obtained, and then return to the scheduling module. If the task parameter is acquired successfully, the scheduling module returns a callback message and fills in a specific parameter value. The user side obtains a callback event through the API module, calls the corresponding plugin service, and returns the plugin execution result through the API module. After the scheduling module obtains a message in which the plugin calls the return result, the scheduling module updates the execution result memory of the plugin and outputs the task from the stack.

According to the technical solutions of the present disclosure, a large language model widely connected to a third-party open source or closed source is combined with a plugin. The development costs of developers in plugin integration, plugin scheduling, and memory maintenance are significantly reduced. A normative plugin registration protocol and a standard access mechanism are provided. A software development kit (SDK) and an API are provided to facilitate integration with user' own applications. The platform side may further operate the plugin ecosystem based on the standardized plugin registration protocol. The plugin system relies on only the understanding and generation capability of the large language model and may widely adapt to closed-source and open-source large language models, thereby improving the versatility of the model. The plugin system adopts general-purpose input and output parameter interface design and may access various types of plugin services widely, thereby improving the universality of the plugin. The plugin system integrates a context learning template based on a prompt, a dedicated intent recognition model, and a dedicated task planning model, so that the accuracy of the calling intent recognition of the plugin can be flexibly optimized in multiple manners. The effect of task analysis, disassembly, and execution plan formulation are greatly improved, so that the prediction effect is flexible and adjustable. The plugin system integrates a memory structure, a global session memory structure, and a parameter acquisition memory structure for multiple rounds of sessions of the plugin. These memory structures can input the sufficient context into the large language model, thereby greatly improving the model understanding accuracy. The plugin system integrates the management of the plugin task to facilitate tracking and managing the execution of the plugin task. The plugin system includes built-in system-level intervention instructions, including entering and/or exiting a specific plugin, clearing a specific memory structure, and resetting a plugin system state. These system-level intervention instructions can efficiently execute the plugin service in an event-triggered plugin calling scenario and use the return result as the input to the large language model.

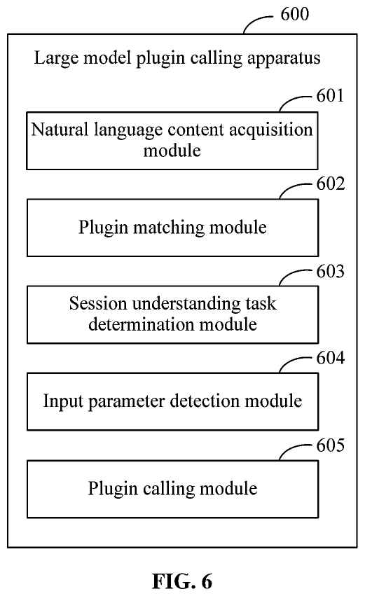

According to an embodiment of the present disclosure, FIG. 6 is a diagram illustrating the structure of an apparatus for invoking a plugin of a large language model according to an embodiment of the present disclosure. This embodiment of the present disclosure is applicable to the case where the plugin is extended for the large language model. The apparatus is implemented as software and/or hardware and is configured in an electronic device having a certain data operation capability. The modules included in the apparatus shown in FIG. 6 may be different from the modules shown in FIG. 4, but the overall functions implemented are the same. The modules in FIG. 4 and FIG. 6 are merely examples, and functions of the modules shown in FIG. 4 or FIG. 6 may be split and reassembled to obtain a new module, which should be included in the scope of the present disclosure.

As shown in FIG. 6, the apparatus 600 includes a natural language content acquisition module 601, a plugin matching module 602, a session understanding task determination module 603, an input parameter detection module 604, and a plugin calling module 605.

The natural language content acquisition module 601 is configured to acquire the natural language content.

The plugin matching module 602 is configured to perform semantic understanding on the natural language content and detect whether the natural language content hits the plugin to obtain the first plugin pointed to by the plugin hit result.

The session understanding task determination module 603 is configured to compare the first plugin with the second plugin corresponding to the current session understanding task to determine the to-be-executed session understanding task.

The input parameter detection module 604 is configured to acquire the language understanding content of the to-be-executed session understanding task and send the language understanding content to the large language model to obtain the input parameter of the third plugin.

The plugin calling module 605 is configured to call the third plugin according to the input parameter of the third plugin to obtain the calling result of the to-be-executed session understanding task.

According to the technical solutions of the present disclosure, semantic understanding is performed on the natural language content. Whether the user intent hits the plugin is detected. The to-be-executed session understanding task is determined according to the plugin hit result. The language understanding content of the session understanding task is acquired and sent to the large language model. The large language model understands the natural language content, and the parameter value of the input parameter required for running the third plugin is extracted, so that the parameter value of the input parameter fed back by the large language model is obtained, and the third plugin is called. The calling result of the session understanding task is obtained. External resources are acquired based on the large language model. The understanding capabilities of the large language model and the external resources may be used to overcome the timeliness defect and resource limitation of the large language model. The application scenarios of language understanding and generation of the large language model system are increased. The prediction accuracy for language understanding generation tasks is improved. Moreover, a variety of plugins may be expanded in real time to increase the diversity and flexibility of extended functions, and the universality of plugins may be increased. At the same time, the large language model does not need to be trained for a scenario to improve the generality of the large language model. At the same time, the plugin pointed to by the plugin hit result is compared with the plugin corresponding to the current session understanding task to determine the to-be-executed session understanding task. Thus, the session understanding task may be planned and determined to avoid unnecessary execution, and execution efficiency is improved.

Further, the session understanding task determination module includes a session interruption detection unit, an interruption task acquisition unit, and a miss dialog feedback unit. The session interruption detection unit is configured to, in the case where the plugin hit result is that the natural language content hits the plugin, to detect whether the session is interrupted to obtain the session interruption detection result. The interruption task acquisition unit is configured to acquire the session understanding task corresponding to the session interruption detection result and determine the session understanding task as the to-be-executed session understanding task. The miss dialog feedback unit is configured to, in the case where the plugin hit result is that the natural language content does not hit the plugin, send the natural language content to the large language model to obtain the feedback content of the large language model.

Further, the session interruption detection unit includes a session holding determination subunit and a session interruption determination subunit. The session holding determination subunit is configured to, in the case where the first plugin is the same as the second plugin, determine that the session interruption detection result is that the session is held. The session interruption determination subunit is configured to, in the case where the first plugin is different from the second plugin, determine that the session interruption detection result is that the session is interrupted. The interruption task acquisition unit includes a holding task acquisition unit, a session recovery detection subunit, and a recovery task acquisition subunit. The holding task acquisition unit is configured to, in the case where the session interruption detection result is that the session is held, determine the current session understanding task as the session understanding task corresponding to the session interruption detection result. The session recovery detection subunit is configured to, in the case where the session interruption detection result is that the session is interrupted, detect whether the historical session is recovered to obtain the session recovery detection result. The recovery task acquisition subunit is configured to acquire the session understanding task corresponding to the session recovery detection result and use the session understanding task as the session understanding task corresponding to the session interruption detection result.

Further, the session recovery detection subunit includes a session recovery determination subunit and a session non-recovery determination subunit. The session recovery determination subunit is configured to, in the case where the first plugin is the same as the fourth plugin corresponding to the historical session understanding task, determine that the session recovery detection result is that the session is recovered. The session non-recovery determination subunit is configured to, in the case where the first plugin is different from the fourth plugin, determine that the session recovery detection result is that the session is not recovered. The recovery task acquisition subunit includes a historical task acquisition unit and a new task establishment subunit. The historical task acquisition unit is configured to, in the case where the session recovery detection result is that the session is recovered, acquire the historical session understanding task and determine the historical session understanding task as the session understanding task corresponding to the session recovery detection result. The new task establishment subunit is configured to, in the case where the session recovery detection result is that the session is not recovered, establish the new session understanding task and determine the new session understanding task as the session understanding task corresponding to the session recovery detection result.

Further, the new task establishment subunit includes a hit plugin acquisition subunit, a plugin task generation subunit, and a session understanding task generation subunit. The hit plugin acquisition subunit is configured to acquire at least one first plugin pointed to by the plugin hit result. The plugin task generation subunit is configured to generate the plugin task corresponding to the first plugin. The session understanding task generation subunit is configured to determine the plugin task corresponding to each first plugin as the new session understanding task.

Further, the new task establishment subunit also includes a plugin task sorting subunit. The plugin task sorting subunit is configured to sort each plugin task. Each plugin task in the new session understanding task is executed according to the sorting result. The input parameter detection module includes a plugin task understanding content acquisition unit and a plugin task parameter detection unit. The plugin task understanding content acquisition unit is configured to acquire the language understanding content of the currently executed plugin task in the to-be-executed session understanding task. The plugin task parameter detection unit is configured to send the language understanding content of the currently executed plugin task to the large language model to obtain the input parameter of the third plugin corresponding to the currently executed plugin task. The plugin calling module includes a plugin task execution unit. The plugin task execution unit is configured to call the third plugin according to the input parameter of the third plugin corresponding to the currently executed plugin task to obtain the calling result of the currently executed plugin task.

Further, the session interruption determination subunit also includes a context determination subunit and a memory storage subunit. The context determination subunit is configured to, in the case where the session interruption detection result is that the session is interrupted, add the natural language content of the current session understanding task to the context of the current session understanding task. The memory storage subunit is configured to store the second plugin corresponding to the current session understanding task and the context corresponding to the current session understanding task in correspondence with the current session understanding task.

Further, the input parameter detection module includes a new task understanding content determination unit, a context acquisition unit, and a historical understanding content determination unit. The new task understanding content determination unit is configured to, in the case where the to-be-executed session understanding task is the new session understanding task, determine the language understanding content of the to-be-executed session understanding task according to the natural language content. The context acquisition unit is configured to, in the case where the to-be-executed session understanding task is different from the new session understanding task, acquire the context of the to-be-executed session understanding task. The historical understanding content determination unit is configured to determine the language understanding content of the to-be-executed session understanding task according to the context of the to-be-executed session understanding task and the natural language content.

Further, the apparatus also includes an intervention command execution module configured to, when the natural language content is the intervention command, adjust the current session understanding task according to the intervention command.

The apparatus may perform a method for invoking a plugin of a large language model according to any embodiment of the present disclosure and has function modules and beneficial effects corresponding to the execution of the method.

In the technical solutions of the present disclosure, the acquisition, storage, use, processing, transmission, provision and disclosure of user personal information involved are in compliance with provisions of relevant laws and regulations and do not violate public order and good customs.

According to embodiments of the present disclosure, also provided are an electronic device, a readable storage medium, and a computer program product.

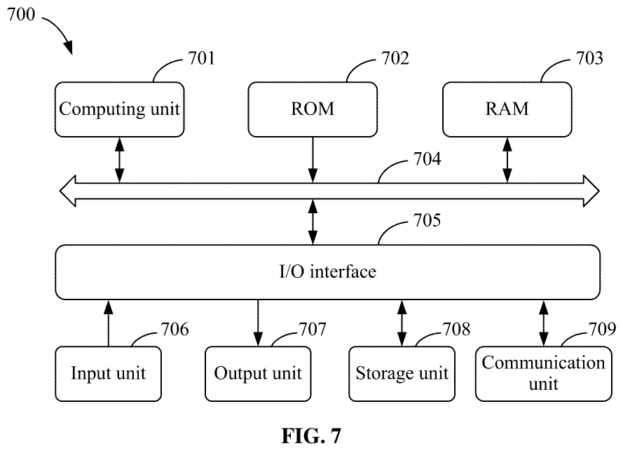

FIG. 7 is a block diagram of an example electronic device 700 for implementing an embodiment of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile apparatuses, for example, a personal digital assistant, a cellphone, a smartphone, a wearable device or a similar computing apparatus. Herein the shown components, the connections and relationships between these components and the functions of these components are illustrative only and are not intended to limit the implementation of the present disclosure as described and/or claimed herein.

As shown in FIG. 7, the device 700 includes a computing unit 701. The computing unit 701 may perform various types of appropriate operations and processing based on a computer program stored in a read-only memory (ROM) 702 or a computer program loaded from a storage unit 708 to a random-access memory (RAM) 703. Various programs and data required for operations of the device 700 may also be stored in the RAM 703. The computing unit 701, the ROM 702 and the RAM 703 are connected to each other through a bus 704. An input/output (I/O) interface 705 is also connected to the bus 704.

Multiple components in the device 700 are connected to the I/O interface 705. The components include an input unit 706 such as a keyboard and a mouse, an output unit 707 such as various types of displays and speakers, the storage unit 708 such as a magnetic disk and an optical disc, and a communication unit 709 such as a network card, a modem and a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Examples of the computing unit 701 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 701 executes various methods and processing described above, such as a method for invoking a plugin of a large language model. For example, in some embodiments, the method may be implemented as computer software programs tangibly contained in a machine-readable medium such as the storage unit 708. In some embodiments, part or all of computer programs may be loaded and/or installed on the device 700 via the ROM 702 and/or the communication unit 709. When the computer program is loaded to the RAM 703 and executed by the computing unit 701, one or more steps of the preceding method may be executed. Alternatively, in other embodiments, the computing unit 701 may be configured, in any other suitable manner (for example, by means of firmware), to perform the method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The at least one programmable processor may be a special-purpose or general-purpose programmable processor for receiving data and instructions from a memory system, at least one input apparatus and at least one output apparatus and transmitting data and instructions to the memory system, the at least one input apparatus and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or regional diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, a machine-readable medium may be a tangible medium that may include or store a program that can be used by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a block chain network and the Internet.

A computer system may include clients and servers. A client and a server are generally remote from each other and typically interact through a communication network. The relationship between the clients and the servers arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a block chain.

Artificial intelligence is a discipline studying the simulation of certain human thinking processes and intelligent behaviors (such as learning, reasoning, thinking and planning) by a computer and involves techniques at both hardware and software levels. Hardware techniques of artificial intelligence generally include techniques such as sensors, special-purpose artificial intelligence chips, cloud computing, distributed storage and big data processing. Software techniques of artificial intelligence mainly include several major directions such as computer vision technology, speech recognition technology, natural language processing technology, machine learning/deep learning technology, big data processing technology and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and block chain.

It is to be understood that various forms of the preceding flows may be used with steps reordered, added or removed. For example, the steps described in the present disclosure may be executed in parallel, in sequence, or in a different order as long as the desired result of the technical solutions provided in the present disclosure is achieved. The execution sequence of these steps is not limited herein.

The scope of the present disclosure is not limited by the preceding embodiments. It is to be understood by those skilled in the art that various modifications, combinations, sub-combinations and substitutions may be made according to design requirements and other factors. Any modification, equivalent substitution and improvement made within the spirit and principle of the present disclosure is within the scope of the present disclosure.

What is claimed is:

1. A method for invoking a plugin of a large language model, comprising:
acquiring natural language content;
performing semantic understanding on the natural language content and detecting whether the natural language content hits a plugin to obtain a first plugin pointed to by a plugin hit result;
comparing the first plugin with a second plugin corresponding to a current session understanding task to determine a to-be-executed session understanding task and a third plugin corresponding to the to-be-executed session understanding task;
acquiring language understanding content of the to-be-executed session understanding task and sending the language understanding content to the large language model to obtain an input parameter of the third plugin; and
calling the third plugin according to the input parameter of the third plugin to obtain a calling result of the to-be-executed session understanding task.

2. The method according to claim 1, wherein comparing the first plugin with the second plugin corresponding to the current session understanding task to determine the to-be-executed session understanding task comprises:
in response to the plugin hit result being that the natural language content hits the plugin, comparing the first plugin with the second plugin, and detecting whether a session is interrupted to obtain a session interruption detection result; and acquiring and determining a session understanding task corresponding to the session interruption detection result as the to-be-executed session understanding task; or
in response to the plugin hit result being that the natural language content does not hit the plugin, sending the natural language content to the large language model to obtain feedback content of the large language model.

3. The method according to claim 2, wherein,
comparing the first plugin with the second plugin, and detecting whether the session is interrupted to obtain the session interruption detection result comprises: in response to the first plugin being the same as the second plugin, determining that the session interruption detection result is that the session is held; or in response to the first plugin being different from the second plugin, determining that the session interruption detection result is that the session is interrupted; and acquiring the session understanding task corresponding to the session interruption detection result comprises: in response to the session interruption detection result being that the session is held, determining the current session understanding task as the session understanding task corresponding to the session interruption detection result; or in response to the session interruption detection result being that the session is interrupted, detecting whether a historical session is recovered to obtain a session recovery detection result; and acquiring and using a session understanding task corresponding to the session recovery detection result as the session understanding task corresponding to the session interruption detection result.

4. The method according to claim 3, wherein,
detecting whether the historical session is recovered to obtain the session recovery detection result comprises: in response to the first plugin being the same as a fourth plugin corresponding to a historical session understanding task, determining that the session recovery detection result is that the session is recovered; or in response to the first plugin being different from the fourth plugin, determining that the session recovery detection result is that the session is not recovered; and
acquiring the session understanding task corresponding to the session recovery detection result comprises: in response to the session recovery detection result being that the session is recovered, acquiring the historical session understanding task and determining the historical session understanding task as the session understanding task corresponding to the session recovery detection result; or in response to the session recovery detection result being that the session is not recovered, establishing a new session understanding task and determining the new session understanding task as the session understanding task corresponding to the session recovery detection result.

5. The method according to claim 4, wherein establishing the new session understanding task comprises:
acquiring at least one first plugin pointed to by the plugin hit result;
generating at least one plugin task corresponding to the at least one first plugin; and
determining the at least one plugin task as the new session understanding task.

6. The method of claim 5, wherein,
the method further comprises sorting the at least one plugin task to obtain a sorting result, wherein the at least one plugin task in the new session understanding task is executed according to the sorting result, and
acquiring the language understanding content of the to-be-executed session understanding task and sending the language understanding content to the large language model to obtain the input parameter of the third plugin comprise: acquiring language understanding content of a currently executed plugin task in the to-be-executed session understanding task; and sending the language understanding content of the currently executed plugin task to the large language model to obtain the input parameter of the third plugin corresponding to the currently executed plugin task; and calling the third plugin according to the input parameter of the third plugin to obtain the calling result of the to-be-executed session understanding task comprises: calling the third plugin according to the input parameter of the third plugin corresponding to the currently executed plugin task to obtain a calling result of the currently executed plugin task.

7. The method of claim 3, further comprising:
in response to the session interruption detection result being that the session is interrupted, adding natural language content of the current session understanding task to a context of the current session understanding task; and
storing the second plugin corresponding to the current session understanding task, the context corresponding to the current session understanding task, and the current session understanding task.

8. The method according to claim 1, wherein acquiring the language understanding content of the to-be-executed session understanding task comprises:
in response to the to-be-executed session understanding task being a new session understanding task, determining the language understanding content of the to-be-executed session understanding task according to the natural language content; or
in response to the to-be-executed session understanding task being different from the new session understanding task, acquiring a context of the to-be-executed session understanding task; and determining the language understanding content of the to-be-executed session understanding task according to the context of the to-be-executed session understanding task and the natural language content.

9. The method of claim 1, further comprising:
in response to the natural language content being an intervention command, adjusting the current session understanding task according to the intervention command.

10-18. (canceled)

19. An electronic device, comprising:
at least one processor; and
a memory communicatively connected to the at least one processor,
wherein the memory stores instructions executable by the at least one processor to enable the at least one processor to execute:
acquiring natural language content;
performing semantic understanding on the natural language content and detecting whether the natural language content hits a plugin to obtain a first plugin pointed to by a plugin hit result;
comparing the first plugin with a second plugin corresponding to a current session understanding task to determine a to-be-executed session understanding task and a third plugin corresponding to the to-be-executed session understanding task;
acquiring language understanding content of the to-be-executed session understanding task and sending the language understanding content to a large language model to obtain an input parameter of the third plugin; and
calling the third plugin according to the input parameter of the third plugin to obtain a calling result of the to-be-executed session understanding task.

20. A non-transitory computer-readable storage medium storing computer instructions for causing a computer to execute:
acquiring natural language content;
performing semantic understanding on the natural language content and detecting whether the natural language content hits a plugin to obtain a first plugin pointed to by a plugin hit result;
comparing the first plugin with a second plugin corresponding to a current session understanding task to determine a to-be-executed session understanding task and a third plugin corresponding to the to-be-executed session understanding task;
acquiring language understanding content of the to-be-executed session understanding task and sending the language understanding content to a large language model to obtain an input parameter of the third plugin; and
calling the third plugin according to the input parameter of the third plugin to obtain a calling result of the to-be-executed session understanding task.

21. The electronic device according to claim 19, wherein the at least one processor is configured to compare the first plugin with the second plugin corresponding to the current session understanding task to determine the to-be-executed session understanding task by:
in response to the plugin hit result being that the natural language content hits the plugin, comparing the first plugin with the second plugin, and detecting whether a session is interrupted to obtain a session interruption detection result; and acquiring and determining a session understanding task corresponding to the session interruption detection result as the to-be-executed session understanding task; or
in response to the plugin hit result being that the natural language content does not hit the plugin, sending the natural language content to the large language model to obtain feedback content of the large language model.

22. The electronic device according to claim 21, wherein,
the at least one processor is configured to compare the first plugin with the second plugin, and detecting whether the session is interrupted to obtain the session interruption detection result by: in response to the first plugin being the same as the second plugin, determining that the session interruption detection result is that the session is held; or in response to the first plugin being different from the second plugin, determining that the session interruption detection result is that the session is interrupted; and
the at least one processor is configured to acquire the session understanding task corresponding to the session interruption detection result by: in response to the session interruption detection result being that the session is held, determining the current session understanding task as the session understanding task corresponding to the session interruption detection result; or in response to the session interruption detection result being that the session is interrupted, detecting whether a historical session is recovered to obtain a session recovery detection result; and acquiring and using a session understanding task corresponding to the session recovery detection result as the session understanding task corresponding to the session interruption detection result.

23. The electronic device according to claim 22, wherein,
the at least one processor is configured to detect whether the historical session is recovered to obtain the session recovery detection result by: in response to the first plugin being the same as a fourth plugin corresponding to a historical session understanding task, determining that the session recovery detection result is that the session is recovered; or in response to the first plugin being different from the fourth plugin, determining that the session recovery detection result is that the session is not recovered; and
the at least one processor is configured to acquire the session understanding task corresponding to the session recovery detection result by: in response to the session recovery detection result being that the session is recovered, acquiring the historical session understanding task and determining the historical session understanding task as the session understanding task corresponding to the session recovery detection result; or in response to the session recovery detection result being that the session is not recovered, establishing a new session understanding task and determining the new session understanding task as the session understanding task corresponding to the session recovery detection result.

24. The electronic device according to claim 23, wherein the at least one processor is configured to establish the new session understanding task by:
acquiring at least one first plugin pointed to by the plugin hit result;
generating at least one plugin task corresponding to the at least one first plugin; and
determining the at least one plugin task as the new session understanding task.

25. The electronic device of claim 24, wherein,
the at least one processor is further configured to sort the at least one plugin task to obtain a sorting result, wherein the at least one plugin task in the new session understanding task is executed according to the sorting result, and
the at least one processor is configured to acquire and send the language understanding content of the to-be-executed session understanding task to the large language model to obtain the input parameter of the third plugin by: acquiring language understanding content of a currently executed plugin task in the to-be-executed session understanding task; and sending the language understanding content of the currently executed plugin task to the large language model to obtain the input parameter of the third plugin corresponding to the currently executed plugin task; and the at least one processor is configured to call the third plugin according to the input parameter of the third plugin to obtain the calling result of the to-be-executed session understanding task by: calling the third plugin according to the input parameter of the third plugin corresponding to the currently executed plugin task to obtain a calling result of the currently executed plugin task.

26. The electronic device of claim 22, wherein the at least one processor is further configured to:
in response to the session interruption detection result being that the session is interrupted, add natural language content of the current session understanding task to a context of the current session understanding task; and
store the second plugin corresponding to the current session understanding task, the context corresponding to the current session understanding task, and the current session understanding task.

27. The electronic device according to claim 19, wherein the at least one processor is configured to acquire the language understanding content of the to-be-executed session understanding task by:
in response to the to-be-executed session understanding task being a new session understanding task, determining the language understanding content of the to-be-executed session understanding task according to the natural language content; or
in response to the to-be-executed session understanding task being different from the new session understanding task, acquiring a context of the to-be-executed session understanding task; and determining the language understanding content of the to-be-executed session understanding task according to the context of the to-be-executed session understanding task and the natural language content.

28. The electronic device of claim 19, wherein the at least one processor is further configured to in response to the natural language content being an intervention command, adjust the current session understanding task according to the intervention command.
